(19) United States
(12) Patent Application Publication
(10) Pub. No.: US 2007/0184173 A1
(43) Pub. Date: Aug. 9, 2007

(54) FOOD PRODUCT AND PROCESS THEREFOR

(75) Inventor: Ferran ADRIA', Barcelona (ES)

Correspondence Address: HESLIN ROTHENBERG FARLEY & MESITI PC, 5 COLUMBIA CIRCLE, ALBANY, NY, 12203, US

(73) Assignee: LUIGI LAVAZZA S.p.A., Torino (IT)

(21) Appl. No.: 11/670,685

(22) Filed: Feb. 2, 2007

(30) Foreign Application Priority Data
Feb. 2, 2006 (IT) TO2006A000071

(51) Int. Cl. A23F 5/00

(52) U.S. Cl. 426/594

(57) ABSTRACT

For the purposes of preparing a food product, a foam including coffee as main ingredient is distributed in a mold and subsequently solidified through freeze-drying. The foam is obtained starting from a respective liquid precursor, which is emulsified through a gas. The liquid precursor also preferably includes a milk product and one or more additives, such as a gelling agent and a sweetener.

### CROSS-REFERENCE TO RELATED APPLICATIONS

This application claims priority from Italian patent application No. T02006A000071, filed on Feb. 2, 2006, the entire disclosure of which is incorporated herein by reference.

### FIELD OF THE INVENTION

The present invention relates to food products and has been developed with particular reference to coffee-based products.

### BACKGROUND ART

In order to allow tasting of coffee and coffee-based preparations, when the conditions for their extemporaneous preparation do not subsist, there have been proposed prepackaged single-dose products, which comprise essentially a cup container, having a removable or pierceable sealing membrane, holding liquid coffee or a coffee-based beverage. The membrane is removed (or pierced by a drinking-straw) and the product is drunk at room temperature, in some cases the container is prearranged for developing an exothermic reaction, in order to heat the beverage (see for instance U.S. Pat. No. 4,793,323). In both the above mentioned solutions the packaging is generally bulky, with respect to the effective product content. The likely presence of preservative, aimed at avoiding a quick perishing of the product, affects in a negative way the organoleptic of the coffee, as perceived by the consumers.

According to other solutions the coffee, in a liquid state, is contained in an edible carrier, namely a chocolate casing. However, production of coffee-filled chocolate is rather complex. This type of product is notably sensitive to temperature and the production thereof is thus a substantially seasonal one. Additionally, when eaten, the chocolate carrier alters the coffee taste, which fact is disliked by certain consumers.

### SUMMARY OF THE INVENTION

The present invention aims essentially at solving the above drawbacks.

According to the present invention, such aim is attained thanks to a product and a process having the characteristics stated in the following claims. The claims form an integral part of the technical teaching provided herein with reference to the invention.

Much briefly, the above aims are attained, according to the invention, by a an aerated (or foamed) food product, and therefore with a low specific weight, substantially consisting of a freeze-dried solid mass of a foam having coffee as a main ingredient.

A typical example of an aerated confectionery product is represented by the so-called “meringue”. By such denomination, a product obtained by solidifying, through cooking, a liquid/foamy mass formed with water, egg white and sugar, supplemented with flavorings, if necessary, is usually shown. IN the present invention, the foamed mass having coffee as its main ingredient, is made to solidify by means of freeze-drying, and not by cooking.

The process according to the invention foresees the preparation of a foamy precursor of the aerated food product, having coffee as a main ingredient, such precursor being subsequently solidified through freeze-drying in order to obtain the solid end product, particularly in the form of an homogeneous, not pulverulent, mass which can be consumed in a single mouthful or, in case, in more bites or mouthfuls.

Within the present description and the appended claims, by the term “coffee” is understood to mean, if not otherwise specified, any beverage organoleptically perceived as coffee, independently of the fact that it is integrally or partly made with coffee. In such a point of view, therefore, within the term coffee there are included, for example, the barley coffee, the malt coffee and similar beverages based on coffee surrogates or substitutes, or all those substitutive products which, without being able to be properly called coffee, for example by virtue of specific rules, imitate in some way the features thereof.

In a preferred but not exclusive embodiment, the aforesaid foamy precursor includes, as an additional ingredient, a milk product.

Within the present invention and the appended claims by the term “milk product” is understood to mean any substance perceived as milk or a part thereof (for example its fat fraction), independently of the fact that such substance is integrally or partly made of animal milk; in such a point of view, within the term milk product there are therefore included, besides the animal milk and the related cream, also substances mainly obtained from the fat fraction of the animal milk, such as the powdered milk and the condensed milk, as well as substitutive products of the animal milk or parts thereof (such as the soy milk, the rice milk, the vegetable cream, etcetera).

Preferably, the used coffee is espresso coffee and the milk product is cow's milk-liquid cream.

Always in the embodiment preferred at the present time, for the purposes of the formation of the aforesaid foam, one or more additives, such as a gelling agent, particularly a food jelly and, if necessary, a sweetener, particularly sugar, are employed.

In the present description and in the appended claims, by the term “sweetener” is understood to mean the sugar, of any origin, and surrogates and substitutes thereof, such as natural (such as for example dextrose and fructose) or artificial (such as for example aspartame and saccharine) sweeteners, both mono- or polysaccharides.

### BRIEF DESCRIPTION OF THE DRAWINGS

Further aims, characteristics and advantages of the invention will become apparent from the following detailed description made with reference to the annexed drawings, which are supplied as a mere non limiting example, wherein:

FIG. 1 is a schematic diagram of an apparatus that can be used in order to obtain, in an industrial context, a precursor of a product according to the invention;

FIG. 2 is a schematic perspective view of a product according to the invention; and

FIG. 3 is a schematic perspective view of a packaging of the product according to the invention.

### DETAILED DESCRIPTION OF PREFERRED EMBODIMENTS OF THE INVENTION

A production process of an aerated food product, according of the invention, will be now provided by mere way of non limiting example. The example provided herein relates to the aforesaid preferred embodiment, according to which the aerated product according to the invention is essentially definable as a “freeze-dried cappuccino foam”; such product is in fact obtained from the drying of a foam whose main ingredients, namely those existing in relative greater quantities over the total or more immediately detectable from the taste point of view, are liquid coffee and a liquid milk product, which notoriously also constitute the more important ingredients of the beverage commonly known as “cappuccino”.

The first step of the process is represented by the preparation of a “cappuccino foam”, which forms a foamy precursor of the end aerated product. Such foam is in turn obtained starting from a respective liquid precursor: in the embodiment exemplified herein, such liquid precursor is obtained by the hot mixing of the coffee, of the milk product, of a gelling agent and a of a sweetener; the mixture thus obtained is subsequently emulsified by means of a gas and cooled at a refrigerator temperature.

In general terms, the ratios of the single ingredients and additives, based on the total weight quantity of the liquid precursor, are the following:

| | |
|---|---|
| coffee: | from 40 to 60% |
| milk product: | from 25 to 45% |
| sweetener: | from 5 to 25% |
| gelling agent: | from 0.3% to 2.3% |

In the practical execution example described herein, the foam is prepared starting from about half a litre of a starting liquid compound formed by:

| | | |
|---|---|---|
| espresso coffee: | 250 g. | 49.85% |
| liquid cream: | 175 g. | 34.90% |
| sugar: | 70 g. | 13.96% |
| food jelly: | 6.5 g. | 1.29% |
| TOTAL | 501.5 g. | 100.00% |

The steps followed for the purposes of the preparation of the foam are the following:

1. the espresso coffee is prepared and dosed (about 255 ml);

2. the cow's milk-liquid cream is warmed by avoiding the boiling thereof, and subsequently dosed (about 180 ml);

3. the additives represented by sugar and (instant and powdered) food jelly are mixed together;

4. the sugar-jelly mixture is dispersed in the vessel containing the still hot coffee, by continuous stirring in order to avoid the clots production;

5. the still hot cream is poured in the above vessel;

6. the liquid compound thus obtained is poured, subject to a possible filtering through a fine-mesh sieve, in a container with a hermetic seal, which in this case is supposed to be a common siphon for food emulsions, of a per se known type;

7. the siphon is tightly closed with the relative cover or plug, which has a relative delivery spout with a push-button valve;

8. within the siphon a propellant gas is insufflated, for example nitrous oxide (N₂O), having the function of emulsifying the liquid compound; such step is carried out by introducing a gas cartridge in a proper threaded cylinder of the siphon, and subsequently screwing the cylinder itself in a proper seat of the aforesaid cover; after the gas insufflation, the exhausted cartridge can be removed;

9. the siphon is stirred for stirring the liquid compound with the gas;

10. the siphon, with its content, is cooled, preferably by maintaining it in a refrigerator cabinet at a temperature of about 4° C. over a time approximately between about 5 and 6 hours (preferably the storage time should not exceed in any case 36 hours).

As already explained, the example above given is merely indicative and should not be intended in a limiting sense, above all with reference to the limited quantity of the starting liquid compound and the use of emulsion containers of a poor capacity; the process above described is in fact feasible for considerably greater volumes and on production plants practicable with the available technology. The example given has to be intended as a non limiting one also with reference to the components of the liquid compound above mentioned, some of which could be omitted and/or replaced.

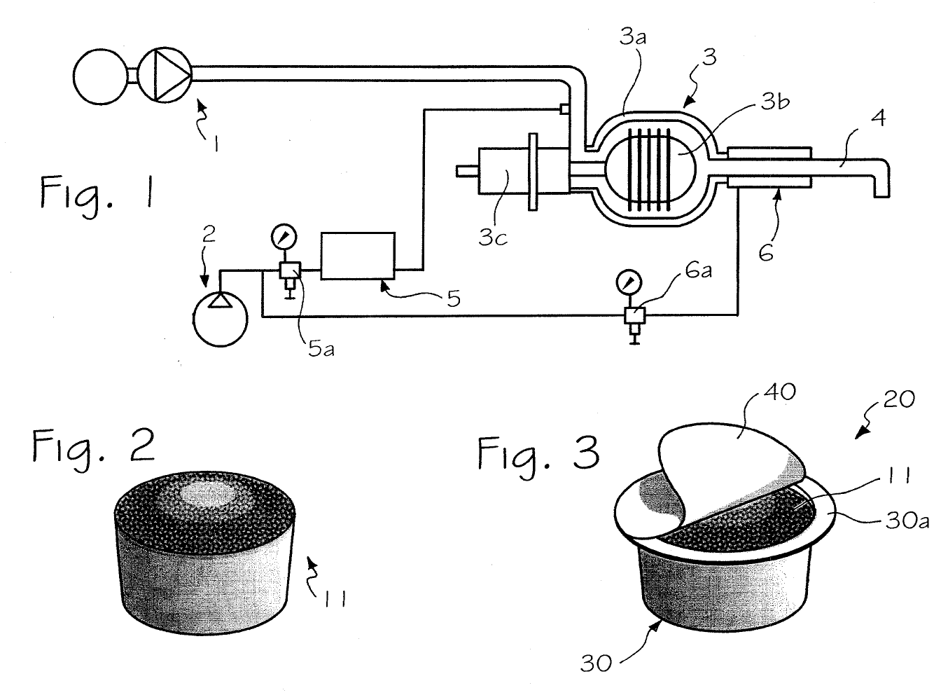

FIG. 1 show in a schematic way an example of an aerating apparatus that can be used for reproducing the results of a siphon, on a larger scale.

In this figure, 1 indicates a pump supplying the starting liquid compound and 2 indicates a source for supplying an emulsifying gas under pressure. 3 indicates a mixing head, comprising a stator 3a, defining a chamber to which the outlet of the pump 1 is connected. Within the stator a movable rotor 3b is mounted, actuated through a respective motor 3c, at least one of the chamber and the rotor of the head having pins. The outlet of the pump 1 is connected to the above cited chamber. 4 indicates an outlet of the head 2, for delivering the foam. 5 indicates a system for injecting in the head 2 the emulsifying gas, having a respective adjusting valve 5a. 6 indicates a system for maintaining a pressure within the head 2, being provided on the outlet 4 and including a respective adjusting valve 6a.

The starting compound is admitted to the head 2 though the pump 5. In the entry of the head 2 a quantity of the compressed gas is admitted, which can be adjusted, by the system 5-5a, which gas can be nitrogen, nitrous oxide or filtered/purified air. The gas/compound mixture is thus greatly intimately blended through the pins of the head 2. Preferably, in order to obtain a good aerated foam at the outlet 4, the head is also maintained on pressure, by the system 6-6a.

The second step of the process subject of the invention is represented by the foam delivery from the relative container (the siphon, in our example) in a relative mold, having for example a body made of silicone material. In the above silicone body, a plurality of alveola, each sized for receiving a respective foam dose intended for forming a single aerated product, can be suitably formed. However, in a particularly advantageous implementation of the invention, the foam is directly dispensed in a single-dose container, which is part of the final package of the product and thus it is also exploited as a mold during the production phase.

After the foam delivery in the mold (with a possible removal of the foam in excess relative to the alveolation) the third step of the process subject of the invention, represented by the freeze-drying process, is carried out.

As it is known, the freeze-drying is a process through which a solvent (normally water) is removed from a food or from a frozen solution, through sublimation of the solvent itself and desorption by means of a reduced pressure or the vacuum. In general terms, the process includes a freezing step, a primary drying step and a secondary drying step.

Freezing

In this step the foam is cooled down until a complete freezing.

The freezing should preferably proceed quickly, with the formation of as small ice crystals as possible.

The cooling temperature is lower or equal to the freezing temperature of the foam; in view of the nature of the food matrix, it seems to be preferable, in any case, a temperature lower or equal to −40° C.

Primary Drying

In such step, the frozen solvent (water) is removed by sublimation, namely by direct passage from the solid state to the aeriform state; this involves, in general terms, that the pressure of the system in which a generic product is processed is lower or close to the triple point of the frozen solvent (namely that particular temperature and pressure condition to which the solid, liquid and aeriform states of the solvent are coexisting).

If, for example, only frozen clear water were processed, the sublimation could take place at 0° C., or close to 0° C., and at an absolute pressure of 4.58 mmHg; however, since the water is often present in a combined state (for example in the foods), the material must usually be processed at temperatures lower than 0° C., so as to maintain the water at the solid state.

In the step in question, it is required to provide the product with a heat quantity equivalent to the sublimation latent heat of the ice (2840 KJ/Kg): this allows to maintain constant the temperature and the consequent drying rate.

In the specific case of the invention, after the freezing, the foam is maintained at a temperature lower than 0° C., within a chamber in which the absolute pressure is approximately lower or equal to 100 μmHg.

The heat required for the sublimation can be provided to the foam by conduction, through a hot metal plate (however, other techniques for the supply of the sublimation heat are clearly possible: by convection of a gas circulating in the chamber, by infrared radiation, by microwave radiation, etcetera). The water vapor formed by the sublimation of the ice crystals is removed, for example, by condensation on a surface kept at a temperature higher than the one of the sublimating ice crystals (alternatively, the vapor could be removed by dragging of a gas circulating in the chamber or only through suctioning of a vacuum pump).

During the primary drying, in the foam the following layers are formed:
a dry and porous outer layer, whose thickness increases with the time (until it concerns the whole product, at the end of the process);
a still frozen inner layer, whose thickness decreases with the time (until it disappears at the end of the process);
a separation surface between the two aforesaid layers, called “sublimation front”.

Secondary Drying

Such step, which is started at the end of the primary drying, involves that water not present at the frozen state, since bound or adsorbed. In the secondary drying step, the de-adsorbed vapor is transported through the pores of the material already dried. In general, the removal of the water bound or adsorbed occurs with the vacuum and at temperatures between 10 and 35° C. for thermosensitive products, and around 50° C. or more for the products less sensitive to the heat.

Also in the specific case of the invention, therefore, once the sublimation has been ended, on the surface of the products there remain water residues; such residues are eliminated by maintaining the vacuum in the processing chamber and rising back the temperature within such chamber at a value higher than 0° C. The maximum temperature of the product in the secondary drying step is preferably lower or equal to 20° C., which is considered the maximum limit which allows to preserve the organoleptic features of the product.

For small quantities of product, as in the embodiment example provided herein, the freezing step can be carried out in the same apparatus which is able to carry out the two following drying steps. Such apparatus, or lyostat, can include a vacuum-tight chamber, in which a series of radiating plates, for example fed, through a circulating pump, by a hot fluid coming from a heat exchanger, is foreseen; the apparatus is completed by a condenser with the relative refrigerator assembly and a pumping assembly for creating the vacuum in the chamber; the condenser typically consists of a set of tubes crossed by a refrigeration fluid.

The mold containing the foam is introduced in the aforesaid chamber, placed on the radiating plates or in their proximity, and the air is evacuated from the chamber itself through the pumping group. After the freezing of the foam, obtained by the refrigerator assembly, the sublimation step is started, during which the required calorific energy is provided by the radiating plates. The vapor thus formed, before reaching the pumping assembly, is intercepted by a condenser coil, on which surfaces the vapor is condensed and transformed in ice. Once the primary drying step is ended, the temperature in the chamber is raised above 0° C., so as to carry out the secondary drying step. Next, the vacuum is stopped and the mold is evacuated from the hermetic chamber. The process times clearly depend on different factors, such as the quantity of processed product, the dimensions of the single product, the dimensions of the processing chamber, etcetera.

Naturally, also the example of freeze-drying process above mentioned is merely indicative and has not to be intended as limitative; in such a point of view, therefore, when large product volumes are processed, the freezing of the foam and the following drying steps could be carried out on different apparatus of a same industrial production plant.

After the evacuation from the freeze-drying apparatus, on the surface of the single products a further powdery ingredient, particularly powdered cocoa, can be dusted; such operation can be carried out, with procedures and means per se known, while the products are still arranged within the alveolas of the mold or in a subsequent moment. Also the removal of the products from the mold takes place with procedures per se known, preferably by exploiting the deformability of the silicone material in which the alveolation is formed. As said above, however, in a particularly advantageous implementation of the invention the mold for the product is embodied by a single-dose container which will make part of the final packaging thereof: in such an implementation, the powder cocoa will be dusted directly on the product contained in the said container, without any extraction being needed in view of the subsequent final packaging.

The products can be then temporarily stored in a dry environment or directly packaged. Considering the high hygroscopicity of the aerated product obtained as above described, the material used for the packaging must have good humidity barrier properties; for this purpose, for the package, any heat-, ultrasonic-, vibration-sealable, etc. synthetic film known for food use can be used. In the above mentioned particularly advantageous implementation of the invention, the single-dose mold/container is directly sealed by means of a closure membrane, for instance being heat-welded.

The process subject of the invention allows to obtain an extremely light and friable solid product, capable of perfectly maintaining the shape assigned thereto by the mold. The shapes assigned to the product could obviously be the most different (biscuit-shaped, bonbon-shaped, etcetera), compatibly with the selected dimensions; the dimensions will substantially be in the order of a mouthful in order to allow the consume of the whole product in a single solution, also if nothing prevents to dimension the product such that the same can be consumable in more bites or mouthfuls. By mere way of example, the aerated product can have a substantially cylindrical or slightly conical shape, with a height of about 2-2.5 cm and a diameter of about 3-3.5 cm.

A schematic example of such a shape is shown at FIG. 2, wherein the product according to the invention is indicated by 11. FIG. 3 then shows an example of final package for the product 11, according to the above particularly advantageous implementation of the invention, the shown package being semi-open.

The package, indicated by 20 as a whole, is configured like a sealed capsule, formed by the container (that, as said, was previously exploited as a mold), indicated by 30, and a sealing membrane 40.

The container 30, whose body is semi-rigid, is preferably formed by a plastic material for food, for instance polypropylene, which is an ideal material for this use, due to its hygiene and functionality, as well as its optimal barrier property. The container 30 has a peripheral wall having a cylindrical shape, or a slightly truncated-cone shape to ease extraction of the product when eaten, and a bottom, non visible in the figure. The upper end of the wall 30 has an outward protruding rim 30a. The container 30 is sealed by means of the membrane 40, which is for instance heat-bonded on the rim 30a. The membrane 40 is preferably a multi-layered membrane, for instance of polypropylene or polypropylene and aluminum, to ensure a perfect sealing.

A substantial advantage of the invention is that the aerated product preserves the flavor and the organoleptic properties of its initial liquid precursor, avoiding significant alterations thereof, such as the protein denaturation. When it is eaten, the aerated product according to the invention is quickly dissolved on the palate. Therefore, it will be appreciated that, thanks to the aforesaid characteristics, the invention offers to the consumers the possibility of tasting at any time a product which accurately reproduces the organoleptic properties of a coffee-based beverage, and particularly of a cappuccino, also when the conditions of normal use or preparation of such beverage (into the car, during an excursion, on the beach, etcetera) are not existing. In such a point of view, it has to be pointed out that the packaged product can be easily stored at ordinary temperature, even for relatively long periods, thus resulting readily transportable.

The invention has been described with reference to a preferred embodiment thereof, in which the main ingredients of the end product are coffee and a milk product. The teaching at the basis of the invention can however be used for the purposes of the preparation of edible aerated coffee-based food products also without a milk ingredient (for example obtained starting from a liquid precursor of the foam including coffee and one or more additives suitable for the object).

Obviously, further without prejudice to the principle of the invention, construction details and embodiments could widely vary with respect to what has been described and shown by mere way of example, without leaving the ambit of the present invention, as it is defined by the appended claims.

1. An aerated food product comprising a freeze-dried solid mass of a foam having coffee as a main ingredient.

2. The product according to claim 1, wherein the foam further comprises a milk product.

3. The product according to claim 1, wherein the foam further comprises one or more additives.

4. The product according to claim 2, wherein the foam further comprises one or more additives and the quantity of milk product is lower, by percent based on the total weight of the foam, than the quantity of coffee and greater than the quantity of the foreseen additive or additives.

5. The product according to claim 3, wherein said additive or additives comprises at least one of a gelling agent and a sweetener.

6. The product according to claim 1, wherein the freeze-dried solid mass is hermetically enclosed in a single-dose package.

7. The product according to claim 6, wherein the package is configured as a capsule comprising a semi-rigid container made of plastic material and having an upper rim onto which a sealing membrane is bonded, the container having a substantially hollow cylindrical or truncated-cone shape and the freeze-dried solid mass having a shape which is substantially complementary to a containment volume defined by the container.

8. A process for making a food product, the process comprising:
preparing a foam having coffee as a main ingredient, and
causing solidification of said foam through freeze-drying, so as to form at least a respective aerated product.

9. The process according to claim 8, further comprising:
introducing said foam within a mold,
obtaining said solidification of said foam introduced in said mold.

10. The process according to claim 8, wherein the preparing said foam comprises:
preparing a liquid precursor of said foam, having coffee as a main ingredient;
emulsifying said liquid precursor through a gas.

11. The process according to claim 8, wherein the preparation of said foam comprises combining the coffee with a milk product.

12. The process according to claim 8, wherein the preparation of said foam comprises combining the coffee with one or more additives.

13. The process according to claims 8, wherein the preparation of said foam comprises combining the coffee with a milk product and one or more additives, wherein the quantity of milk product is greater, by percent based on the total weight of the foam, than the quantity of coffee and lower than the quantity of the foreseen additive or additives.

14. The process according to claim 12, wherein the additive or the additives comprises at least one of a gelling agent and a sweetener.

15. The process according to claim 10, wherein said liquid precursor is formed by combining together coffee, a milk product, a gelling agent and a sweetener.

16. The process according to claim 15, wherein said liquid precursor comprises, by percent based on its total weight:
not less than 40% of coffee;
not less than 25% of milk product;
not less than 5% of sweetener;
not less than 0.3% of gelling agent.

17. The process according to claim 15, wherein
the coffee is espresso coffee, and/or
the milk product is animal milk cream, and/or
the gelling agent is a powdered food jelly, and/or
the sweetener is sugar.

18. The process according to claim 15, wherein the preparing said liquid precursor comprises:
preparing the coffee;
dispersing the additive or additives in the still hot coffee and mixing the compound thus obtained;
warming the liquid-shaped milk product and inhibiting boiling thereof;
adding the milk product to said compound.

19. The process according to claim 18, wherein the emulsifying said liquid precursor comprises:
adding a pressurized gas to the liquid precursor;
mixing the liquid precursor with the gas.

20. The process according to claim 8, wherein the causing solidification by means of freeze-drying comprises:
subjecting the foam to freezing;
subjecting the foam at a primary drying or sublimation step, and
subjecting the foam at a secondary drying step.

21. The process according to claim 9, wherein said operation of introducing comprises at least one of:
distributing said foam in an alveolation of said mold, and,
removing the foam in excess with respect to said alveolation.

22. The process according to claim 9, wherein the mold is configured as a container that embodies at least part of single-dose package of the product.

23. The process according to claim 22, further comprising sealing said container by a membrane through heat-bonding.

24. The process according to claim 8, further comprising dusting on the aerated product a further ingredient in a powdery form, said ingredient comprising powdered cocoa.

25. A process for making a food product, comprising:
preparing a liquid compound having coffee as a main ingredient,
emulsifying said liquid compound through a gas, for the purpose of obtaining a foamy precursor of an aerated product,
providing a single-dose container for the product,
introducing said foamy precursor in said container,
solidifying said foamy precursor introduced in said container through freeze-drying, so as to form at least a respective aerated product, and
hermetically sealing said container.
